(19) United States
(12) Patent Application Publication
(10) Pub. No.: US 2024/0267089 A1
(43) Pub. Date: Aug. 8, 2024

(54) ANTENNA APPARATUS AND ELECTRONIC DEVICE

(71) Applicant: Realme Mobile Telecommunications (Shenzhen) Co., Ltd, Shenzhen (CN)

(72) Inventors: Zhiyong PENG, Shenzhen (CN); Xianhua ZHANG, Shenzhen (CN); Zeheng WU, Shenzhen (CN); Mingyang LIU, Shenzhen (CN); Lv WANG, Shenzhen (CN); Zheng LI, Shenzhen (CN); Ziman ZHUANG, Shenzhen (CN); Binxian CHEN, Shenzhen (CN); Jinlin CHEN, Shenzhen (CN); Tao ZHANG, Shenzhen (CN)

(73) Assignee: Realme Mobile Telecommunications (Shenzhen) Co., Ltd, Shenzhen (CN)

(21) Appl. No.: 18/434,363

(22) Filed: Feb. 6, 2024

(30) Foreign Application Priority Data
Feb. 8, 2023 (CN) 202310153089.4

(51) Int. Cl. H04B 7/0404; H01Q 1/24

(52) U.S. Cl. CPC H04B 7/0404; H01Q 1/243

(57) ABSTRACT

The present application provides an antenna apparatus and an electronic device. The antenna apparatus includes a first radiator, a second radiator, and a control module. An isolation degree between the second radiator in an operating state and the first radiator in a first state is greater than an isolation degree between the second radiator in the operating state and the first radiator in a second state. The control module is configured to control the first radiator to be in the first state in response to the second radiator being in the operating state.

### CROSS-REFERENCE TO RELATED APPLICATIONS

The present application claims priority to Chinese Patent Application No. 202310153089.4, entitled “ANTENNA APPARATUS AND ELECTRONIC DEVICE”, filed Feb. 8, 2023, which is herein incorporated by reference in its entirety.

### TECHNICAL FIELD

The present disclosure relates to the field of communication technologies, and in particular to an antenna apparatus and an electronic device.

### BACKGROUND

With the development of communication technology, an electronic device such as a smartphone or the like may achieve more and more functions, and the communication modes of the electronic device are becoming more diverse. There are also more and more antenna radiators disposed inside the electronic device.

However, due to the limitations of miniaturization design of the electronic device, there is large interference between multiple antenna radiators, and the radiation performance of the multiple antenna radiators is poor.

### SUMMARY OF THE DISCLOSURE

In a first aspect, the present disclosure provides an antenna apparatus including a first radiator, a second radiator, and a control module.

The first radiator includes a first state and a second state.

The second radiator is configured to support transmission of a wireless signal in an operating state. An isolation degree between the second radiator in the operating state and the first radiator in the first state is greater than an isolation degree between the second radiator in the operating state and the first radiator in the second state.

The control module is electrically connected to the first radiator and the second radiator. The control module is configured to control the first radiator to be in the first state in response to the second radiator being in the operating state.

In a second aspect, the present disclosure further provides an electronic device including an antenna apparatus and a housing.

The antenna apparatus is the above antenna apparatus.

The housing defines an accommodating space. The first radiator is located in the accommodating space, and at least part of the second radiator is connected to the housing and located outside the accommodating space.

### BRIEF DESCRIPTION OF THE DRAWINGS

In order to more clearly illustrate the technical solutions in some embodiments of the present disclosure, hereinafter, a brief introduction will be given to the accompanying drawings that are used in the description of some embodiments. Obviously, the accompanying drawings in the description below are merely some embodiments of the present disclosure. For those of ordinary skill in the art, other accompanying drawings may be obtained based on these accompanying drawings without any creative efforts.

FIG. 1 is a first structural schematic view of an antenna apparatus in some embodiments of the present disclosure.

FIG. 2 is a schematic view of a first electrical connection of the antenna apparatus shown in FIG. 1.

FIG. 3 is a schematic view of a second electrical connection of the antenna apparatus shown in FIG. 1.

FIG. 4 is a first structural schematic view of an electronic device provided in some embodiments of the present disclosure.

FIG. 5 is a second structural schematic view of the electronic device provided in some embodiments of the present disclosure.

FIG. 6 is a third structural schematic view of the electronic device provided in some embodiments of the present disclosure.

FIG. 7 is an application scene schematic view of the electronic device provided in some embodiments of the present disclosure.

FIG. 8 is a fourth structural schematic view of the electronic device in some embodiments of the present disclosure.

FIG. 9 is a structural exploded schematic view of the electronic device shown in FIG. 8.

FIG. 10 is a fifth structural schematic view of the electronic device in some embodiments of the present disclosure.

### DETAILED DESCRIPTION

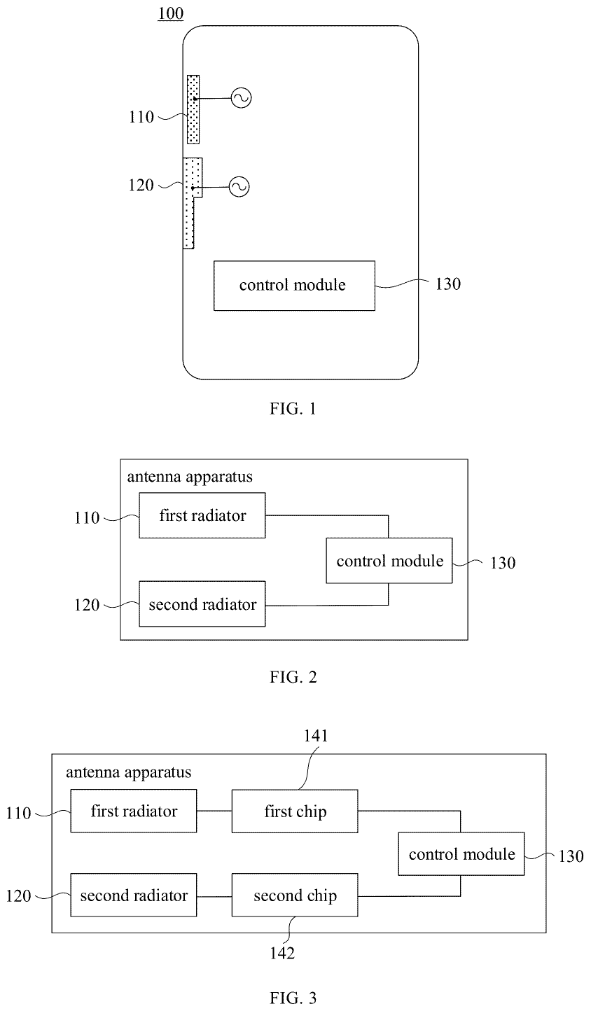

The technical solutions in some embodiments of the present disclosure may be clearly and completely described in conjunction with accompanying FIGS. 1 to 10 in some embodiments of the present disclosure. Obviously, the described embodiments are only a part of the embodiments of the present disclosure, and not all embodiments. Based on the embodiments in the present disclosure, all other embodiments obtained by those of ordinary skill in the art without creative effort are within the scope of the present disclosure.

The reference to “embodiments” in the present disclosure means that, specific features, structures, or characteristics described in conjunction with some embodiments may be included in at least one embodiment of the present disclosure. The phrase appearing in various positions in the specification does not necessarily refer to the same embodiment, nor is it an independent or alternative embodiment that is mutually exclusive with other embodiments. Those of ordinary skill in the art explicitly and implicitly understand that the embodiments described in the present disclosure may be combined with other embodiments.

The present disclosure provides an antenna apparatus and an electronic device, which may control and adjust a state of at least one of a plurality of radiators according to states of the plurality of radiators, ensuring the radiation performance of the radiators.

Embodiments of the present disclosure provide an antenna apparatus and an electronic device, and the antenna apparatus may achieve wireless communication function. For example, the antenna apparatus may transmit wireless fidelity (Wi-Fi) signals, global positioning system (GPS) signals, third generation mobile communication technology (3rd-Generation, 3G) signals, fourth generation mobile communication technology (4th-Generation, 4G) signals, and fifth generation mobile communication technology (5th-Generation, 5G) signals, near field communication (NFC) signals, Bluetooth signals, ultra-wideband communication signals, etc.

As illustrated in FIGS. 1 and 2, FIG. 1 is a first structural schematic view of an antenna apparatus 100 in some embodiments of the present disclosure, and FIG. 2 is a schematic view of a first electrical connection of the antenna apparatus 100 shown in FIG. 1. The antenna apparatus 100 may include a first radiator 110, a second radiator 120, and a control module 130.

The first radiator 110 and the second radiator 120 may be conductive structures and may both support transmission of a wireless signal. For example, the second radiator 120 may support the transmission of a first wireless signal in a first frequency band in response to the second radiator 120 being in an operating state. The first radiator 110 may have a first state and a second state. A first isolation degree is between the first radiator 110 in the first state and the second radiator 120 in the operating state. A second isolation degree is between the first radiator 110 in the second state and the second radiator 120 in the operating state. The first isolation degree may be greater than the second isolation degree. The control module 130 may be directly or indirectly electrically connected to the first radiator 110, and may also be directly or indirectly electrically connected to the second radiator 120. The control module 130 may control the first radiator 110 to be in the first state in response to the second radiator 120 being in the operating state, so as to reduce mutual interference between the first radiator 110 and the second radiator 120.

An isolation degree between two radiators refers to a ratio of a power of a signal emitted by one radiator to a power of a signal received by the other radiator. The greater the isolation degree between the two radiators, the less likely it is that the other radiator receives the signal emitted by the previous radiator, and the less interference between the two radiators. On the contrary, the smaller the isolation degree between the two radiators, the more signals the other radiator may receive the signal emitted by the previous radiator, and the greater the interference between the two radiators. In response to the first isolation degree between the first radiator 110 in the first state and the second radiator 120 in the operating state being greater than the second isolation degree between the first radiator 110 in the second state and the second radiator 120 in the operating state, the degree of mutual interference between the second radiator 120 and the first radiator 110 in the first state is less than the degree of mutual interference between the second radiator 120 and the first radiator 110 in the second state. Compared with the first radiator 110 in the second state, in response to the first radiator 110 being in the first state, the first radiator 110 is less likely to interfere with the second radiator 120, and the radiation performance of the second radiator 120 is better.

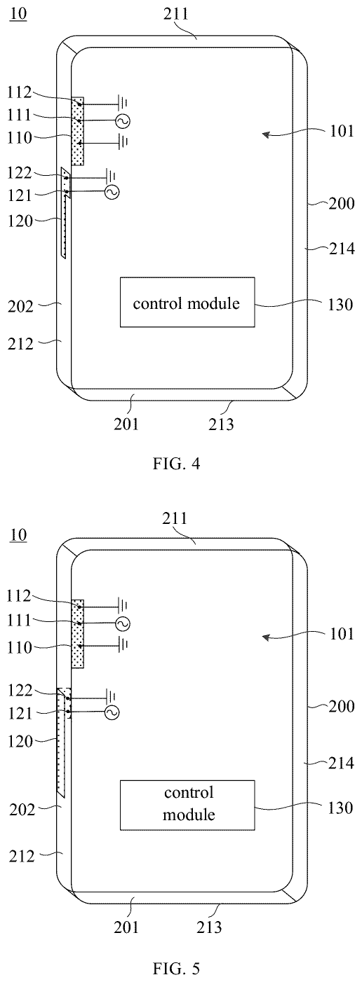

The control module 130 may be a main control chip in an electronic device 10 (as shown in FIG. 4), such as, but not limited to, a processor circuit of the electronic device 10. In some embodiments, the control module 130 may also be other modules in the electronic device 10. For example, the control module 130 may be a baseband chip. The baseband chip refers to a chip structure configured for information processing, protocol processing, and signal processing. For example, the baseband chip may be configured to synthesize a baseband signal to be transmitted, decode a received baseband signal, and edit a phone number, a website address, a short message text, a website text, and image information etc. The embodiments of the present disclosure do not limit a specific structure of the control module 130.

The control module 130 may control a current state of the first radiator 110 and a current state of the second radiator 120. For example, the control module 130 may control the second radiator 120 to be in the operating state and support the transmission of the first wireless signal in the first frequency band. The control module 130 may further control the second radiator 120 to be in a non-operating state and not support the transmission of the wireless signal. For example, the control module 130 may control the first radiator 110 to be in the first state, and a higher isolation degree is between the first radiator 110 and the second radiator 120. The control module 130 may further control the first radiator 110 to be in the second state, and a lower isolation degree is between the first radiator 110 and the second radiator 120. A specific operating mode of the control module 130 is not limited in the embodiments of the present disclosure.

In some embodiments, the first state of the first radiator 110 may be an operating state of the first radiator 110. For example, the first radiator 110 may support the transmission of a second wireless signal in a second frequency band in the first state. The second state of the first radiator 110 may be another operating state of the first radiator 110. For example, the first radiator 110 may support the transmission of the second wireless signal in the third frequency band in the second state. A first frequency difference between the second frequency band and the first frequency band supported by the second radiator 120 in the operating state may be greater than a frequency difference between the third frequency band and the first frequency band (a center frequency of the second frequency band, a center frequency of the first frequency band, and a center frequency of the third frequency band may be selected for comparison). Thus, a distance between the second frequency band and first frequency band on a spectrum is greater than a distance between the third frequency band and first frequency band on the spectrum. According to a radiation law of the antenna, in response to the frequency difference of the wireless signals supported by the two radiators being large, the mutual interference between the two radiators is small, and the isolation degree between the two radiators is large. On the contrary, in response to the frequency difference between the wireless signals supported by two radiators being small, the mutual interference between the two radiators is greater, and the isolation degree between the two radiators is smaller. In some embodiments of the present disclosure, the frequency difference between the second frequency band supported by the first radiator 110 in the first state and the first frequency band supported by the second radiator 120 is greater, the control module 130 adjusts the first radiator 110 to be in the first state and support the second frequency band in response to the second radiator 120 supporting the first frequency band, which may reduce mutual interference between the first radiator 110 and the second radiator 120.

In some embodiments, the second state of the first radiator 110 may be a state in which the first radiator 110 supports the transmission of the wireless signal, while the first state of the first radiator 110 may be a state in which the first radiator 110 is in a sleep or off state, so that the first radiator 110 does not support the transmission of the wireless signal in response to the first radiator 110 operated in the first state. In this case, the first radiator 110 may not interfere with the second radiator 120 in response to the first radiator 110 being in the first state. The control module 130 may control the first radiator 110 to be in the first state in response to the second radiator 120 being in the operating state, so as to reduce mutual interference between the first radiator 110 and the second radiator 120.

The above description is only an exemplary explanation of the first state and the second state of the first radiator 110. The first state and the second state may also be other states, such as, but not limited to, different main radiation directions of the first radiator 110 in the first state and the second state, resulting in different isolation degrees between the first radiator 110 and the second radiator 120 in two states. The embodiments of the present disclosure do not provide specific limitations on the first state and the second state of the first radiator 110. Any first state and second state that may meet the isolation degree between the second radiator 120 in the operating state and the first radiator 110 in the first state greater than the isolation degree between the second radiator 120 in the operating state and the first radiator 110 in the second state are within a protection scope of the present disclosure.

In the electronic device 10 of the embodiments of the present disclosure, the isolation degree between the second radiator 120 in the operating state and the first radiator 110 in the first state is greater than the isolation degree between the second radiator 120 in the operating state and the first radiator 110 in the second state. The control module 130 controls the first radiator 110 to be in the first state in response to the second radiator 120 being in the operating state. In this case, the isolation degree between the first radiator 110 and the second radiator 120 is higher, the first radiator 110 has less interference to the second radiator 120, and the radiation performance of the second radiator 120 is better. Moreover, the control module 130 of the present disclosure may flexibly control the state of the first radiator 110 based on the state of the second radiator 120, thereby reducing interference between two radiators and improving the radiation performance of the second radiator 120. The antenna apparatus 100 reduces mutual interference between two radiators in a simpler and easier to operate way.

As illustrated in FIG. 3, FIG. 3 is a schematic view of a second electrical connection of the antenna apparatus 100 shown in FIG. 1. The antenna apparatus 100 may further include at least one of a first chip 141 and a second chip 142.

The first chip 141 may be directly or indirectly electrically connected to the first radiator 110, and the first chip 141 may also be directly or indirectly electrically connected to the control module 130. The first chip 141 may control the first radiator 110 to be in the first state, or control the first radiator 110 to be in the second state. The control module 130 may control the first chip 141 during the second radiator 120 being in the operating state, to control the first radiator 110 through the first chip 141, and allow the first radiator 110 to be in the first state.

The second chip 142 may be directly or indirectly electrically connected to the second radiator 120, and the second chip 142 may also be directly or indirectly electrically connected to the control module 130. The second chip 142 may control the current state of the second radiator 120. For example, the second chip 142 may control the second radiator 120 to be in the operating state and support the first wireless signal in the first frequency band. The control module 130 may receive feedback information from the second chip 142 to determine whether the second radiator 120 is in the operating state. In response to the second radiator 120 being in the operating state, the control module 130 may control the first chip 141 to adjust the current state of the first radiator 110 to the first state.

The first radiator 110 may be in the second state by default, and the second state may be the preferred operating state of the first radiator 110. In response to the second radiator 120 being in the operating state, due to the large interference between the first radiator 110 in the second state and the second radiator 120, the control module 130 or the first chip 141 may control the first radiator 110 to switch to the first state, so as to reduce the interference between the first radiator 110 and the second radiator 120. In response to the second radiator 120 being in the operating state and the first radiator 110 is in the first state, the control module 130 or the first chip 141 may maintain the current first state of the first radiator 110.

In response to the control module 130 or the second chip 142 determining that the second radiator 120 does not need to be in the operating state, the control module 130 or the second chip 142 may turn off the second radiator 120, or control the second radiator 120 to be in the sleep state, or control the second radiator 120 to switch to another state with less interference with the second state of the first radiator 110 (for example, the second radiator 120 is switched to be in a fourth state that supports the wireless signal in a fourth frequency band, and a frequency difference between the fourth frequency band and the third frequency bands is greater than the frequency difference between the first frequency band and the third frequency band). Moreover, the control module 130 or the first chip 141 may control the first radiator 110 to switch back to the second state, so that the first radiator 110 has better radiation performance.

In some embodiments, in response to the control module 130 receiving an instruction that requires the first radiator 110 to be operated in the second state, the control module 130 or the first chip 141 may control the first radiator 110 to switch back to the second state. In this case, in order to ensure the radiation performance of the first radiator 110 in the second state, the control module 130 or the second chip 142 may turn off the second radiator 120, or control the second radiator 120 to be in the sleep state, or control the second radiator 120 to switch to another state with less interference with the second state of the first radiator 110.

The first chip 141 and the second chip 142 may be a chip or a feed source element that excites the radiator to support the wireless signals. For example, the first chip 141 may serve as a first feed source and provide an excitation signal to the first radiator 110, so as to excite the first radiator 110 to support the first wireless signal. The second chip 142 may serve as a second feed source and provide the excitation signal to the second radiator 120, so as to excite the second radiator 120 to support the second wireless signal. For example, the first radiator 110 may support the transmission of a cellular signal, and in this case, the first chip 141 may be a cellular chip. The second radiator 120 may support the transmission of a Wi-Fi signal (such as a 2.4G Wi-Fi signal, or a 2.5G Wi-Fi signal) during the second radiator 120 being in the operating state, in this case, the second chip 142 may be a Wi-Fi chip. The cellular signal refers to a signal transmitted by a cellular network, and the cellular network is also known as a mobile network. A common type of the cellular network includes a GSM network, a CDMA network, a 3G network, a FDMA network, a TDMA network, etc. The cellular chip and the Wi-Fi chip are electronic elements that may convert the radio signal communication into a certain radio signal waveform and send the radio signal waveform through an antenna resonance (such as the first radiator 110, the second radiator 120). The cellular chip and the Wi-Fi chip may be responsible for information transmission and reception, frequency synthesis, power amplification. The cellular chip may be responsible for transmission and reception of the cellular signal, and the Wi-Fi chip may be responsible for transmission and reception of the Wi-Fi signal. In response to the control module 130 being the baseband chip or includes a function of the baseband chip, the baseband chip may be responsible for processing the cellular signal and the Wi-Fi signal of the cellular chip and the Wi-Fi chip, and processing corresponding protocols. The specific structures of the control module 130, the first chip 141, and the second chip 142 are not limited in the embodiments of the present disclosure.

In response to the first chip 141 being the cellular chip that enables the first radiator 110 to support the cellular signal and the second chip 142 is the Wi-Fi chip that enables the second radiator 120 to support the 2.4G Wi-Fi signal or the 5G Wi-Fi signal, the first radiator 110 may support a certain cellular signal in the second state, such as B40 (2300 MHz˜2400 MHz) frequency band or B7 (2500 MHz˜2600 MHz) frequency band. The B40 frequency band or the B7 frequency band is closer to a frequency band of the 2.4G Wi-Fi signal. The mutual interference between the B40 frequency band and the frequency band of the 2.4G Wi-Fi signal and the mutual interference between the B7 frequency band and the frequency band of the 2.4G Wi-Fi signal are large. In response to the antenna apparatus 100 or the control module 130 detecting that the antenna apparatus 100 enters a Wi-Fi scene, such as a game, esports, or a movie and television, etc., the control module 130 or the second chip 142 may control the second radiator 120 to be in the operating state, such as supporting the transmission of the 2.4G Wi-Fi signal. The control module 130 or the first chip 141 may control the first radiator 110 to be in the first state, such as supporting the cellular signal in another frequency band farther away from the 2.4G Wi-Fi signal, such as the B3 (1710 MHz-1880 MHz) frequency band. Due to the large distance between the B3 frequency band and the 2.4G Wi-Fi frequency band, the isolation degree between the B3 frequency band and the 2.4G Wi-Fi frequency band is large. Thus, it may simultaneously ensure the radiation performance of the B3 signal supported by the first radiator 110 and the radiation performance of the 2.4G Wi-Fi signal supported by the second radiator 120. The radiation performances of the cellular scene and the Wi-Fi scene of the antenna apparatus 100 are better, resulting in a better user experience.

In response to the antenna apparatus 100 or the control module 130 detecting that the antenna apparatus 100 does not need to enter the Wi-Fi scene, such as the game, the esports, the movie and television, or needs to focus on the cellular application scene, the control module 130 or the first chip 141 may control the first radiator 110 to be in the second state and support the B40 frequency band or the B7 frequency band. The mutual interference between the B40 frequency band and the 2.4G Wi-Fi frequency band and the mutual interference between the B7 frequency band and the 2.4G Wi-Fi frequency band are large. In this case, the control module 130 or the second chip 142 may control the second radiator 120 and turn off the second radiator 120, or control the second radiator 120 to be in the sleep state, or control the second radiator 120 to switch to a scene that supports the 5G Wi-Fi signal. Due to the large distance between the frequency band of the 5G Wi-Fi signal and the B40 or the large distance between the frequency band of the 5G Wi-Fi signal and B7 frequency band, the isolation degree between the frequency band of the 5G Wi-Fi signal and the B40 or the isolation degree between the frequency band of the 5G Wi-Fi signal and B7 frequency band is large. Thus, it may simultaneously ensure that the radiation performance of the wireless signal of the B40 frequency band or the B7 frequency band supported by the first radiator 110, and the radiation performance of the 5G Wi-Fi signal supported by the second radiator 120. The radiation performances of the cellular scene and the Wi-Fi scene of the antenna apparatus 100 are better, resulting in the better user experience.

The antenna apparatus 100 or the electronic device (such as the electronic device 10 below) may control and adjust the states of the first radiator 110 and the second radiator 120 according to the application scene.

For example, in general, the scene of the operating state of the second radiator 120 (such as the Wi-Fi scene) may be at the highest priority, and the antenna apparatus 10 or the electronic device may preferentially control based on the state of the second radiator 120. For example, in response to the second radiator 120 being in the operating state, the first radiator 110 is controlled to be in the first state. In order to ensure the performance of the first radiator 110, the first radiator 110 in the first state may support the transmission of the second wireless signal in the second frequency band (such as the cellular signal in the B3 frequency band).

In some embodiments, for example, in response to the antenna apparatus 100 or the electronic device receiving preferentially maintaining the application scene of the second state of the first radiator 110 (such as in a cellular call scene), the antenna apparatus 100 or the electronic device may allow the application scene of the second state of the first radiator 110 to be the highest priority. In this case, even though it is detected that the antenna apparatus 100 or the electronic device needs to enter a scene that is the operating state of the second radiator 120, it may first ensure and maintain the application scene of the second state of the first radiator 110 (during this process, the second radiator 120 may be turned off, or the second radiator 120 may be controlled to be in the sleep state, or the second radiator 120 may be controlled to switch to the fourth state with less interference with the second state of the first radiator 110), until the end of the application scene or the application scene does not need to be maintained (such as not being in the cellular call scene). In response to the antenna apparatus 100 or the electronic device still needing to enter the scene that is the operating state of the second radiator 120 at this time, corresponding control may be implemented based on the operating state of the second radiator 120.

The antenna apparatus 100 or the electronic device may also comprehensively determine the priority of the second state of the first radiator 110 and the operating state of the second radiator 120 based on the quality of the signal transmitted by the first radiator 110 and the quality of the signal transmitted by the second radiator 120. For example, in response to the quality of the signal transmitted by the first radiator 110 being better, It may ensure that the first radiator 110 is in the second state and control the second radiator 120 to be in a high isolation degree state from the first radiator 110 (for example, the control module 130 or the second chip 142 may turn off the second radiator 120, or control the second radiator 120 to be in the sleep state, or control the second radiator 120 to switch to another state with less interference with the second state of the first radiator 110). For example, in response to the quality of the signal transmitted by the second radiator 120 being better, it may be ensured that the second radiator 120 is in the operating state and control the first radiator 110 to be in the first state with high isolation degree from the second radiator 120.

The above description is only an exemplary explanation of a control mode of the antenna apparatus 100 or the electronic device to the first radiator 110 and the second radiator 120 in the embodiments of the present disclosure. The embodiments of the present disclosure do not provide specific limitations on the control mode.

In the antenna apparatus 100 of the embodiments of the present disclosure, in response to the control module 130 with the baseband chip function detecting that the second chip 142 (such as the Wi-Fi chip) is in the operating state (such as detecting the transmission and reception of the Wi-Fi signal data in the first frequency band), the control module 130 may send an instruction to the first chip 141 (such as the cellular chip). After receiving the instruction, the first chip 141 may adjust the first radiator 110 to be in the first state, so that the first radiator 110 and the second radiator 120 are in a high isolation degree state, thereby reducing the impact of the first radiator 110 on the radiation performance of the second radiator 120, and further optimizing the antenna performance.

The first radiator 110 and the second radiator 120 may also support the wireless signals of other types and frequency bands. In this case, the first chip 141 and the second chip 142 may also be other types of chips, such as, but not limited to, GPS chips, Bluetooth chips, ultra-wideband chips, etc. The wireless signals supported by the first radiator 110 and the second radiator 120 in the embodiments of the present disclosure are not limited, and the specific types and structures of the first chip 141 and the second chip 142 are not limited.

As illustrated in FIG. 3, the control module 130 may indirectly control the states of the first radiator 110 and the second radiator 120 through the first chip 141 and the second chip 142. As illustrated in FIG. 2, the control module 130 may also directly control the states of the first radiator 110 and the second radiator 120. The control module 130 may also control the states of the first radiator 110 and the second radiator 120 in other ways, which are not limited in the embodiments of the present disclosure.

Based on the structure of the antenna apparatus 100 mentioned above, as illustrated in FIG. 4, FIG. 4 is a first structural schematic view of an electronic device 10 provided in some embodiments of the present disclosure. The electronic device 10 may be a smartphone, a tablet, a gaming device, an augmented reality (AR) device, an automotive device, a data storage device, an audio playback device, a video playback device, a laptop, or a desktop computing device, etc. The electronic device 10 may include the antenna apparatus 100 in any one of the above embodiments.

As illustrated in FIG. 4, the electronic device 10 may further include a housing 200. The housing 200 may form an outer shell of the electronic device 10. The housing 200 forms an accommodating space 101. The electronic elements or the functional components in the electronic device 10 may be disposed in the accommodating space 101, and the housing 200 may provide support for these electronic elements or functional components, so as to install the electronic elements or the functional components together. For example, a structure, such as a groove, a protrusion, a through holes, etc., may be formed on the housing 200, so as to facilitate the installation of the electronic devices or the functional components of electronic device 10.

The housing 200 may be made of a non-conductive material, or a non-conductive area may be disposed on the housing 200, so that the housing 200 is not easy to form a metal shielding element. The signals radiated by the radiators inside the housing 200 may be transmitted to a free space.

The housing 200 may include a first surface 201 and a second surface 202 opposite to each other. The first surface 201 may be an inner surface of the housing 200, the inner surface may be located in the accommodating space 101, and a user cannot see the first surface 201 from the outside of the electronic device 10. The second surface 202 may be an outer surface of the housing 200, and the second surface 202 may be located outside the accommodating space 101. The user may see the second surface 202 from the outside of the electronic device 10. The control module 130, first chip 141, and second chip 142 of antenna apparatus 100 may be disposed in the accommodating space 101.

The first radiator 110 of the antenna apparatus 100 may be located in the accommodating space 101. For example, but not limited to, the first radiator 110 may be located on the first surface 201 of the housing 200, or the first radiator 110 may be located on a bracket or other carrier in the accommodating space 101.

A first feeding part 111 may be disposed on the first radiator 110, so as to receive the excitation signal. For example, the first chip 141 may be directly or indirectly electrically connected to the first radiator 110 through the first feeding part 111, so as to achieve electrical connection with the first radiator 110 and provide the excitation signal to the first radiator 110.

A first grounding part 112 may be disposed on the first radiator 110. The first grounding part 112 may be directly or indirectly electrically connected to a ground system, so as to facilitate the return to ground of the excitation signal. A ground system is a plane or a structure with zero potential. The ground system may form a common ground. The ground system may be formed through conductors, printed circuits, or metal printed layers of antenna apparatus 100 or the electronic device 10. The first radiator 110 may be equipped with one or more first grounding parts 112. For example, as illustrated in FIGS. 4 and 5, the first radiator 110 may include two first grounding parts 112. In response to the first radiator 110 being in the first state, the excitation signal may return to ground from one of the first grounding parts 112. In response to the first radiator 110 being in the second state, the excitation signal may be returned to ground from another first grounding part 112. In response to the first radiator 110 including one first grounding part 112, an electrical length of the first radiator 110 may be changed through an inductor, a capacitor, or other elements, so that the first radiator 110 in different states. The specific mode in which the first radiator 110 has the first state and the second state is not limited in the embodiments of the present disclosure.

The excitation signal flows on the first radiator 110, which may but is not limited to, excite the first radiator 110 to form a quarter wavelength mode, a half wavelength mode, a three-quarter wavelength mode, etc. A specific antenna mode of the first radiator 110 is not limited in the embodiments of the present disclosure.

The first radiator 110 may be a radiator with a flexible circuit board (FPC) structure, and the first radiator 110 may be a radiation structure in the form of the FPC. The first radiator 110 may also be a radiation structure in the form of laser-direct-structure (LDS), or a radiation structure in the form of printing direct structure (PDS). A specific formation process of the first radiator 110 is not limited in the embodiments of the present disclosure. Any structure of the first radiator 110 that may be disposed inside the accommodating space 101 of the housing 200 may be in the protection range of the embodiments of the present disclosure.

At least part of the second radiator 120 may be connected to the housing 200 and disposed outside the accommodating space 101. For example, as illustrated in FIG. 4, entire second radiator 120 may be disposed on the second surface 202 of the housing 200. For example, as illustrated in FIG. 5, FIG. 5 is a second structural schematic view of the electronic device 10 provided in some embodiments of the present disclosure. One part of the second radiator 120 may be disposed on the second surface 202 of the housing 200, while another part of the second radiator 120 may bypass the second surface 202 and extend to the first surface 201, so that this part of the second radiator 120 may be connected to the first surface 201 of the housing 200. Another part of the second radiator 120 disposed in the accommodating space 101 is more easily fed and grounded.

The second radiator 120 may be the radiator with the FPC structure. Due to the superior flexibility and bendability of the FPC structure, entire second radiator 120 may be connected to the second surface 202 of the housing 200. Alternatively, one part of the second radiator 120 may be connected to the second surface 202 of the housing 200, and another part of the second radiator 120 may be bent and connected to the first surface 201 of the housing 200. A connection between the second radiator 120 and the housing 200 is more fit and firm. Moreover, the flexible second radiator 120 may also serve as a waterproof layer of the housing 200. The FPC structure has a certain stretchability and may meet waterproof and soft pressure requirements of the housing 200. A water vapor outside the housing 200 is not easy to enter the housing 200 through the second radiator 120, which may improve the sealing performance of the housing 200. The second radiator 120 may also be other radiation structures, such as, but not limited to, a radiation structure in the form of LDS, or a radiation structure in the form of PDS. A specific structure of the second radiator 120 is not limited in the embodiments of the present disclosure.

A second feeding part 121 may be disposed on the second radiator 120, so as to receive the excitation signal. For example, the second chip 142 may be directly or indirectly electrically connected to the second radiator 120 through the second feeding part 121, so as to achieve electrical connection with the second radiator 120 and provide the excitation signal to the second radiator 120. In response to one part of the second radiator 120 extending to the first surface 201 of the housing 200 and located in the accommodating space 101, the second feeding part 121 may be disposed on this part of the second radiator 120, so as to facilitate electrical connection between the second feeding part 121 and the second chip 142 in the accommodating space 101. In response to entire second radiator 120 being connected to the second surface 202 of the housing 200 and located outside the accommodating space 101, the second feeding part 121 is disposed on the second surface 202. In this case, the second chip 142 may be electrically connected to the second feeding part 121 through a metal via hole, a metal trace, or other modes.

A second grounding part 122 may also be disposed on the second radiator 120. The second grounding part 122 may be directly or indirectly electrically connected to the ground system, so as to facilitate the return to ground of the excitation signal. The excitation signal flows on the second radiator 120, which may but is not limited to, excite the second radiator 120 to form the quarter wavelength mode, the half wavelength mode, the three-quarter wavelength mode, etc. A specific antenna mode of the second radiator 120 is not limited in the embodiments of the present disclosure.

In response to the electronic element, such as a circuit board 400 (as shown in FIG. 8), being disposed in the accommodating space 101 of electronic device 10, since at least part of the second radiator 120 is located on the outer surface of the housing 200, the second radiator 120 of this part is further away from the circuit board 400 than the first radiator 110. Compared with the first radiator 110, the second radiator 120 of this part has at least one clearance area height with a housing thickness. The so-called antenna clearance refers to a size of a space of the antenna area without metal. A role of disposing the clearance area in the antenna is mainly to keep the metal and other conductors away from the antenna radiator, so as to avoid the impact of the metal on the performance of the antenna radiator (such as weakening radiation performance by metal shielding, changing the resonant frequency of the antenna radiator by changing the size of the clearance area, and changing the division of near-field radiation and far-field radiation of the antenna, etc.). Generally speaking, the larger the antenna clearance area, the greater the radiation performance of the antenna radiator. However, due to the limitations of the size and internal spatial layout of the electronic device 10, the clearance area of the antenna radiator inside the electronic device 10 is small. In the embodiments of the present disclosure, at least part of the second radiator 120 is located on the housing 200 outside the accommodating space 101, and the clearance area of the second radiator 120 of this part is larger, thus the radiation performance of the second radiator 120 is better.

In the electronic device 10 of the embodiments of the present disclosure, the housing 200 defines the accommodating space 101, and at least part of the second radiator 120 is connected to the housing 200 and disposed outside the accommodating space 101. Compared with the radiators disposed inside the accommodating space 101, at least part of the second radiator 120 may have an additional clearance area height with the housing thickness. This part of the second radiator 120 may be away from the conductor structure disposed inside the electronic device 10, thereby further improving the radiation performance of the second radiator 120.

As illustrated in FIGS. 4 and 5, the housing 200 includes a first side frame 211, a second side frame 212, and a third side frame 213 sequentially connected. The second radiator 120 may be disposed opposite to the second side frame 212.

The first side frame 211 to the third side frame 213 may be outer side frames of the electronic device 10. The first side frame 211 and the third side frame 213 may be opposite to each other. The second side frame 212 may be bent relative to the first side frame 211 and the third side frame 213, and be connected to the first side frame 211 and the third side frame 213, respectively. A length of the first side frame 211 and a length of the third side frame 213 may be smaller than a length of the second side frame 212, so that the first side frame 211 and the third side frame 213 may be short side frames of the electronic device 10, and the second side frame 212 may be a long side frame of the electronic device 10.

As illustrated in FIGS. 4 and 5, the housing 200 may further include a fourth side frame 214. The first side frame 211, the second side frame 212, the third side frame 213, and the fourth side frame 214 are sequentially connected. The fourth side frame 214 may be disposed opposite to the second side frame 212. The length of the first side frame 211 and the length of the third side frame 213 may be smaller than a length of the fourth side frame 214. The fourth side frame 214 may also be the long side frame of the electronic device 10. FIGS. 4 and 5 are only illustrative examples of a shape of electronic device 10. The electronic device 10 is not limited to a rectangular shape. For example, the electronic device 10 may also have a pentagonal structure or a hexagonal structure, which is not limited in the embodiments of the present disclosure.

A projection of the second radiator 120 on the housing 200 may be located on the second side frame 212, so that the second radiator 120 is disposed opposite to the second side frame 212. For example, the second radiator 120 may be connected to the outer surface of the second side frame 212. The second radiator 120 may be located in a middle area of the second side frame 212. There may be a first distance between the second radiator 120 and the first side frame 211. There may be a second distance between the second radiator 120 and the third side frame 213. A ratio of the first distance to the second distance may range from two-thirds to one and a half. That is, the ratio of the first distance to the second distance may be greater than or equal to two-thirds and less than or equal to one and a half.

The first distance may be a distance between a center point of the second radiator 120 and the first side frame 211. And correspondingly, the second distance may be a distance between the center point of the second radiator 120 and the third side frame 213. In response to the ratio of the first distance to the second distance ranging from two-thirds to one and a half, the second radiator 120 may be located in the middle area of the second side frame 212. It is difficult for the user to hold or block the second radiator 120 during holding the electronic device 10.

A projection of the first radiator 110 on the housing 200 may also be located on the second side frame 212, so that the first radiator 110 may also be disposed opposite to the second side frame 212. For example, the first radiator 110 may be disposed on the inner surface of the second side frame 212 (such as the first surface 201 mentioned above). A first projection of the first radiator 110 on the second side frame 212 may at least partially overlap with a second projection of the second radiator 120 on the second side frame 212. For example, the first projection may completely overlap with the second projection, or the first projection may partially overlap with the second projection. In this case, the first radiator 110 may be disposed on the inner surface of the second side frame 212, and the second radiator 120 may be located on the outer surface of the second side frame 212 (such as the second surface 202 mentioned above). Thus, the layout of the two radiators is more compact, which may achieve miniaturization design of the antenna apparatus 100 and the electronic device 10. In some embodiments, the first projection may also be separated from the second projection. In this case, the distance between the first radiator 110 and the second radiator 120 is greater, and the mutual influence between the first radiator 110 and the second radiator 120 is smaller.

In the present disclosure, in response to the ratio of the distance from the second radiator 120 to the first side frame 211 to the distance from the second radiator 120 to the third side frame 213 ranging from two-thirds to one and a half, the second radiator 120 is not easy to be held by the user, and a user's holding state is not easy to affect the radiation performance of the second radiator 120. The second radiator 120 may maintain better radiation performance in the user's holding state.

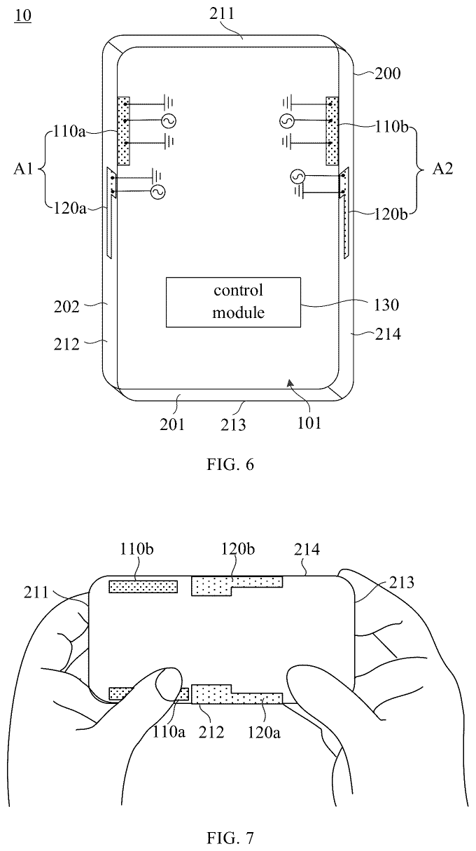

As illustrated in FIG. 6, FIG. 6 is a third structural schematic view of the electronic device 10 provided in some embodiments of the present disclosure. The antenna apparatus 100 or the electronic device 10 may include a plurality of (two or more) first radiators 110 and a plurality of (two or more) second radiators 120.

The number of first radiators 110 may be equal to the number of second radiators 120, such as, the number being N. One first radiator 110 and one second radiator 120 may form an antenna group, and the antenna apparatus 100 or the electronic device 10 may include a plurality of antenna groups, such as N antenna groups.

The control module 130 may be directly or indirectly electrically connected to each first radiator 110, and directly or indirectly electrically connected to each second radiator 120. The control module 130 may control the state of another second radiator 120 in an antenna group based on the state of the first radiator 110 in the same antenna group. For example, the control module 130 may control the first radiator 110 in the antenna group to be in the first state in response to the second radiator 120 in the antenna group being in the operating state.

The control module 130 may control each antenna group based on the same control logic. For example, the control module 130 may simultaneously control the states of the first radiators 110 in all antenna groups, and the states of the second radiators 120 in the antenna groups. In some embodiments, the control module 130 may also control each antenna group separately according to the states of the different antenna groups. The embodiments of the present disclosure do not limit the specific control logic of the control module 130.

The plurality of first radiators 110 may form a multiple-input multiple-output (MIMO) transmission system. The control module 130 may simultaneously control the states of the plurality of first radiators 110. For example, the control module 130 may simultaneously control the plurality of first radiators 110 to be in the first state and support the wireless signals in the second frequency band. Alternatively, the control module 130 may simultaneously control the plurality of first radiators 110 in the second state and support the wireless signals in the third frequency band. Similarly, the plurality of second radiators 120 may also form the MIMO transmission system, and the control module 130 may simultaneously control the status of the plurality of second radiators 120. For example, the control module 130 may simultaneously control the plurality of second radiators 120 to be in the operating state and support the wireless signals in the first frequency band. The plurality of first radiators 110 or the plurality of second radiators 120 transmitted by the MIMO transmission system may improve data transmission throughput and speed.

The antenna apparatus 100 and the electronic device 10 of the embodiments of the present disclosure include the plurality of antenna groups, and the control module 130 may control and adjust according to the states of the first radiator 110 and the second radiator 120 in each antenna group, thereby reducing mutual interference between the first radiator 110 and the second radiator 120 in each antenna group.

As illustrated in FIG. 6, the electronic device 10 may include at least two antenna groups, such as a first antenna group A1 and a second antenna group A2. The first antenna group A1 may include a first radiator 110a and a first second radiator 120a, and the second antenna group A2 may include another first radiator 110b and another second radiator 120b. At least one antenna group, such as the first antenna group A1, may be disposed opposite to the second side frame 212, and at least another antenna group, such as the second antenna group A2, may be disposed opposite to the fourth side frame 214.

The first antenna group A1 is disposed opposite to the second side frame 212, which may refer to projections of the first radiator 110a and the second radiator 120a of the first antenna group A1 on the housing 200 located on the second side frame 212. Similarly, the second antenna group A2 is disposed opposite to the fourth side frame 214, which may refer to projections of the first radiator 110b and the second radiator 120b of the second antenna group A2 on the housing 200 located on the fourth side frame 214.

The second radiator 120 (such as the second radiator 120a or the second radiator 120b) of each antenna group is disposed opposite to the second side frame 212 and the fourth side frame 214. The ratio of the first distance between the second radiator 120 of each antenna group and the first side frame 211 to the second distance between the second radiator 120 of each antenna group and the third side frame 213 may range from two-thirds to one and a half, so that each second radiator 120 may be disposed in the middle area of the long side frame of the electronic device 10.

In response to the second radiator 120 supporting the first wireless signal of the first frequency band, the electronic device 10 may include at least two second radiators 120 disposed on the long side frame of the electronic device 10. The user's holding state is not easy to affect the radiation performance of the second radiator 120 during holding the electronic device 10.

In some embodiments, as illustrated in FIG. 7, FIG. 7 is an application scene schematic view of the electronic device 10 provided in some embodiments of the present disclosure. In response to the user horizontally holding the electronic device 10, hands of the user are likely to cover the first side frame 211 and the third side frame 213. It is difficult for the user's hands to hold the second radiator 120a disposed opposite to the second side frame 212, or another second radiator 120b disposed opposite to the fourth side frame 214. The second radiator 120a and the second radiator 120b are not easily affected by the user's holding. Moreover, under the control of the control module 130, in response to the second radiator 120a and the second radiator 120b being in the operating states, the control module 130 controls the first radiator 110a and the first radiator 110b to be in the first states. In this case, the second radiator 120a and the second radiator 120b may have better radiation performance in a landscape handheld scene.

For example, in response to the second radiator 120 supporting the first wireless signal of the first frequency band (such as the Wi-Fi signal), in relevant technical solutions, the second radiator 120a and the second radiator 120b are not disposed in the middle area of the second side frame 212 and the fourth side frame 214 (such as at a connection of two adjacent side frames, or on the first side frame 211 and the third side frame 213). The control module 130 does not adjust the state of the first radiator 110 to allow the first radiator 110 to be in the second state. In the relevant technical solutions, the antenna efficiency of the second radiator 120a and the second radiator 120b in a free space state (i.e., a state is that the user does not hold the electronic device 10 with both hands) is about −5 dB, the antenna efficiency in a landscape left hand holding state (a state as shown in FIG. 7) is about −8 dB, the antenna efficiency is about −10 dB in a landscape right hand holding state (a landscape state contrary to the state as shown in FIG. 7, so that the user's two thumbs cover the fourth side frame 214 of the electronic device 10).

In the embodiments of the present disclosure, the second radiator 120a and the second radiator 120b are disposed in the middle area of the second side frame 212 and the fourth side frame 214, and the control module 130 adjusts the state of the first radiator 110 and allows the first radiator 110 to be in the first state. In this case, the antenna efficiency of the second radiator 120a and the second radiator 120b in the free space state is about−5 dB, the antenna efficiency of the second radiator 120a and the second radiator 120b in the landscape left hand holding state is about −5.3 dB, and the antenna efficiency of the second radiator 120a and the second radiator 120b in the landscape right hand holding state is about −5.4 dB. Thus, in the present disclosure, the second radiator 120a and the second radiator 120b are disposed in the middle areas of the second side frame 212 and the fourth side frame 214. After being controlled and adjusted by the control module 130, the efficiency reduction of the second radiator 120a and the second radiator 120b in the landscape left hand holding state and the landscape right hand holding state are both less than 0.5 dB, which is much smaller than the reduction of the radiator in related technologies. Thus, the second radiator 120 of the embodiments of the present disclosure has better radiation performance. Moreover, the antenna apparatus 100 and electronic device 10 of the embodiments of the present disclosure are combined with the implementation of AOL function (Advanced open loop, i.e., switching and adjusting matching or changing an equivalent resonance length of the antenna through a switch). In response to the control module 130 (such as baseband chip) detecting that the second chip 142 (such as the Wi-Fi chip) is in the operating state (such as detecting the transmission and reception of the Wi-Fi signal data in the first frequency band), the control module 130 may send the instruction to the first chip 141 (such as the cellular chip). After receiving the instruction, the first chip 141 may adjust the first radiator 110a and the first radiator 110b to be the first state, so that the first radiator 110a and the first radiator 110b, and the second radiator 120a and the second radiator 120b are in the high isolation degree states, thereby reducing the impact of the first radiator 110a and the first radiator 110b on the second radiator 120a and the second radiator 120b, thereby further optimizing the antenna performance. Furthermore, in response to the second radiator 120a and the second radiator 120b being designed in the FPC form on the outer surfaces of the middle areas of the second side frame 212 and the fourth side frame 214, the clearance heights of the second radiator 120a and the second radiator 120b may be further increased, which not only meets the needs of structural waterproofing and soft pressure, but also optimizes the antenna performance. Moreover, in response to the second radiator 120a and the second radiator 120b supporting the Wi-Fi signals, the antenna apparatus 100 and the electronic device 10 of the embodiments of the present disclosure have better Wi-Fi performance. The second radiator 120a and the second radiator 120b may form dual esports Wi-Fi antennas, and the antenna apparatus 100 and the electronic device 10 of the embodiments of the present disclosure are particularly suitable for the game scene and the esports scenes.

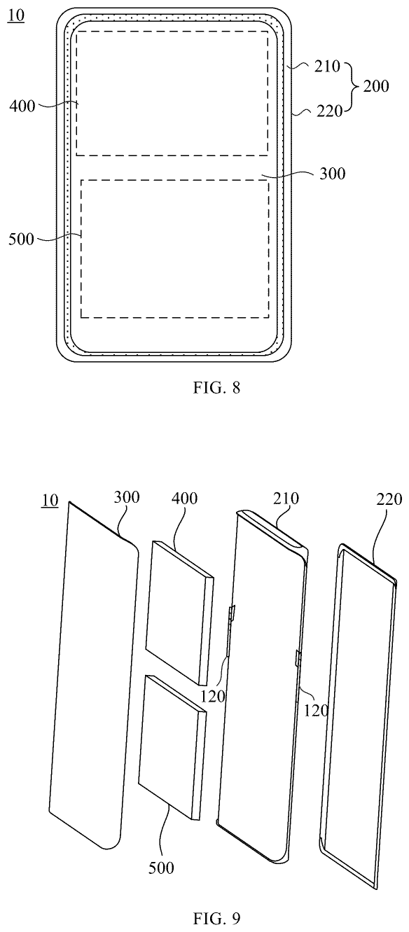

As illustrated in FIGS. 8 and 9, FIG. 8 is a fourth structural schematic view of the electronic device 10 in some embodiments of the present disclosure, and FIG. 9 is a structural exploded schematic view of the electronic device 10 shown in FIG. 8. The housing 200 of the electronic device 10 may include a middle frame 210 and a rear housing 220. The electronic device 10 may further include a display screen 300, a circuit board 400, and a battery 500.

The middle frame 210 may be a thin or sheet-like structure, or a hollow frame structure. The middle frame 210 is configured to provide support for the electronic elements or the functional components of the electronic device 10, so as to install the electronic elements and the functional components of electronic device 10 together. The middle frame 210 may include the first side frame 211 to the fourth side frame 214 in the aforementioned embodiments, and the middle frame 210 may form the outer side frame of the electronic device 10.

The display screen 300 may be disposed on the middle frame 210 and connected to the rear housing 220 through the middle frame 210, so as to form a display surface of the electronic device 10. The display screen 300 is configured to display information, such as an image or a text. The display screen 300 may include a liquid crystal display (LCD), an organic light-emitting diode (OLED) display screen, or other types of displays.

The rear housing 220 is connected to the middle frame 210, to form the accommodating space 101. The control module 130, the first chip 141, the second chip 142, the battery 500, the circuit board 400, and the like may be disposed in the accommodating space 101. For example, the rear housing 220 may be bonded to the middle frame 210 through an adhesive, such as a double-surfaced tape, so as to achieve connection with the middle frame 210. The rear housing 220 is configured to seal the electronic elements and the functional components of the electronic device 10 inside the electronic device 10 together with the middle frame 210 and the display screen 300, to form a protective effect on the electronic elements and the functional components of the electronic device 10.

The first radiator 110 may be disposed in the accommodating space 101 formed by connecting the rear housing 220 and the middle frame 210. The first radiator 110 may be disposed on an inner side surface of the middle frame 210, and the first radiator 110 may also be disposed on an inner side surface of the rear housing 220. The first radiator 110 may further be disposed on other structures in the accommodating space 101. The specific disposing position of the first radiator 110 is not limited in the embodiments of the present disclosure.

At least part of the second radiator 120 may be located on a side surface of the middle frame 210 away from the accommodating space 101. At least part of the second radiator 120 may also be located on a side surface of the rear housing 220 away from the accommodating space 101. At least part of the second radiator 120 may be simultaneously located on the side surface of the middle frame 210 away from the accommodating space 101 and the side surface of the rear housing 220 away from the accommodating space 101. The embodiments of the present disclosure do not limit the specific disposing position of the second radiator 120.

In the aforementioned embodiments, the first side frame 211 to the fourth side frame 214 may be four side frames of the middle frame 210 or four side frames of the rear housing 220, which are not limited by the embodiments of the present disclosure.

The circuit board 400 may be fixed on the middle frame 210 and sealed inside the electronic device 10 through the rear housing 220. The circuit board 400 may be a main board of the electronic device 10. The circuit board 400 may be integrated with a processor. In addition, the circuit board 400 may also be integrated with one or more functional components, such as a headphone interface, an acceleration sensor, a gyroscope, a motor, etc. Moreover, the display screen 300 may be electrically connected to the circuit board 400 to control the display of the display screen 300 through the processor on the circuit board 400. The control module 130, the first chip 141, and the second chip 142 may be disposed on the circuit board 400. In some embodiments, the above structures may also be disposed on a small board or other carrier board of the electronic device 10, which is not limited in the embodiments of the present disclosure.

The battery 500 is disposed on the middle frame 210 and sealed inside the electronic device 10 through the rear housing 220. Furthermore, the battery 500 is connected to the circuit board 400 to provide power to the electronic device 10. The circuit board 400 may be equipped with a power management circuit. The power management circuit is configured to distribute a voltage provided by the battery 500 to various electronic elements of the electronic device 10.

The ground system may be disposed on the circuit board 400, the rear housing 220, and the middle frame 210. In some embodiments, the ground system may also be disposed on other small boards and carrier boards of the electronic device 10, which is not limited in the embodiments of the present disclosure.

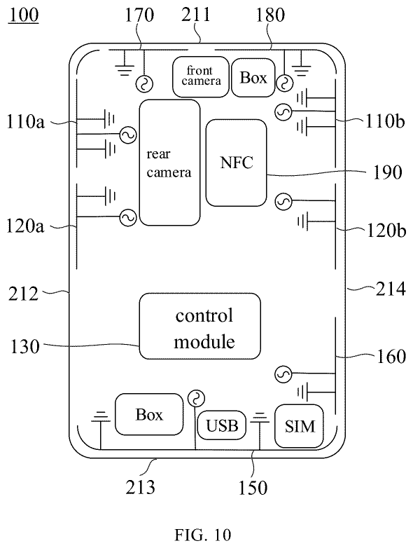

As illustrated in FIG. 10, FIG. 10 is a fifth structural schematic view of the electronic device 10 in some embodiments of the present disclosure. The antenna apparatus 100 of the embodiments of the present disclosure may further include more radiators, such as at least one of a third radiator 150, a fourth radiator 160, a fifth radiator 170, a sixth radiator 180, and a seventh radiator 190.

The third radiator 150 may be disposed opposite to the third side frame 213, and a projection of the third radiator 150 on the housing 200 may be located on the third side frame 213. The third radiator 150 may be grounded, for example, the third radiator 150 may include one or more grounding parts, so as to be electrically connected to the ground system, thereby achieving grounding. The antenna apparatus 100 may further include an element that provides the excitation signal for the third radiator 150, such as a third feed source. The third radiator 150 may support a third wireless signal under the action of the excitation signal. The third wireless signal may be, but is not limited to, a low frequency signal, a medium frequency signal, or a high frequency signal. The third radiator 150 may serve as a radiator of the low frequency signal, the medium frequency signal, and the high frequency signal in a primary receiving (PRX) mode. For example, in response to the electronic device 10 being in a standalone (SA) mode, the third radiator 150 may support the transmission of signals in a N1 frequency band, a N3 frequency band, a N40 frequency band, a N41 frequency band, a N5 frequency band, a N8 frequency band, or a N28A frequency band in a PRX mode. For example, in response to the electronic device 10 being in a non-standalone (NSA) mode, the third radiator 150 and other radiators may support the N1 frequency band, the N3 frequency band, the N40 frequency band, or the N41 frequency band in a MIMO transmission mode of the PRX mode; or the third radiator 150 may support the N5 frequency band, the N8 frequency band, or the N28A frequency band in the PRX mode. The embodiments of the present disclosure do not limit the wireless signals supported by the third radiator 150.

The fourth radiator 160 may be disposed opposite to the fourth side frame 214, and a projection of the fourth radiator 160 on the housing 200 may be located on the fourth side frame 214. One end of the fourth radiator 160 may be spaced apart from one end of the third radiator 150, and the other end of the fourth radiator 160 may extend along a direction away from the third radiator 150. The fourth radiator 160 may be grounded. The antenna apparatus 100 may further include an element that provides the excitation signal for the fourth radiator 160, such as a fourth feed source. The fourth radiator 160 may support the fourth wireless signal under the action of the excitation signal. The fourth wireless signal may be a L5 frequency band signal of GPS, or the fourth wireless signal may be the low frequency signal, the medium frequency signal, or the high frequency signal. For example, the fourth radiator 160 may support the N41 frequency band or a N78 frequency band in the MIMO transmission mode of the PRX mode in the SA mode or the NSA mode. The embodiments of the present disclosure do not limit the wireless signals supported by the fourth radiator 160.

The fifth radiator 170 may be disposed opposite to the first side frame 211, and a projection of the fifth radiator 170 on the housing 200 may be located on the second side frame 212. The fifth radiator 170 may be grounded. The antenna apparatus 100 may further include an element that provides the excitation signal for the fifth radiator 170, such as a fifth feed source. The fifth radiator 170 may support the fifth wireless signal under the action of the excitation signal. For example, the fifth radiator 170 may support signals in a L1 frequency band of GPS. For example, the fifth radiator 170 may support a N77 frequency band or the N78 frequency band in a diversity receiving (DRX) mode in the SA mode or the NSA mode. The embodiments of the present disclosure do not limit the wireless signals supported by the fifth radiator 170.

At least part of the sixth radiator 180 may be disposed opposite to the first side frame 211, and a projection of the at least part of the sixth radiator 180 on the housing 200 may be located on the first side frame 211. For example, a part of the sixth radiators 180 may be disposed opposite to the first side frame 211, and another part of the sixth radiators 180 may be disposed opposite to the fourth side frame 214. The sixth radiator 180 may be grounded. The antenna apparatus 100 may further include an element that provides the excitation signal for the sixth radiator 180, such as a sixth feed source. The sixth radiator 180 may support the sixth wireless signal under the action of the excitation signal. For example, the sixth radiator 180 may support the low frequency signal in the DRX mode. For example, the sixth radiator 180 may support the transmission of signals in a B1 frequency band, a B3 frequency band, a B40 frequency band, or a B41 frequency band in the MIMO transmission mode of the PRX mode. For example, the sixth radiator 180 may support the transmission of signals in the N1 frequency band, the N3 frequency band, the N40 frequency band, or the N41 frequency band in the MIMO transmission mode of the PRX mode in the SA mode. For example, the sixth radiator 180 may support the transmission of signals in the N5 frequency band, the N8 frequency band, or the N28A frequency band in the DRX mode in the SA mode. For example, the sixth radiator 180 may support the transmission of signals in the N1 frequency band, the N3 frequency band, the N40 frequency band, or the N41 frequency band in the PRX mode in the NSA mode. For example, the sixth radiator 180 may support the transmission of signals in the N5 frequency band, the N8 frequency band, or the N28A frequency band in the DRX mode in the NSA mode. The embodiments of the present disclosure do not limit the wireless signals supported by the sixth radiator 180.

The seventh radiator 190 may be located in the accommodating space 101, for example, the seventh radiator 190 may be located on the inner side surface of the rear housing 220. The seventh radiator 190 may support an NFC signal to achieve NFC function of the electronic device 10. In some embodiments, the seventh radiator 190 may also be installed on other structures and may support other wireless signals. The embodiments of the present disclosure do not limit the wireless signals supported by the fourth radiator 160.

In response to the second radiator 120 being disposed opposite to the middle area of the second side frame 212 or the fourth side frame 214, the second radiator 120 may support the Wi-Fi signal, such as the 2.4G Wi-Fi signal or the 5G Wi-Fi signal. In response to the electronic device 10 including the plurality of second radiators 120, such as the second radiator 120a and the second radiator 120b, the two second radiators 120 may form the MIMO transmission system, such as a MIMO transmission system that may form the 2.4G Wi-Fi signal or the 5G Wi-Fi signal. In this case, the two second radiators 120 may form the dual esports antennas and have better radiation performance in the game scene of the electronic device 10, resulting in the better user experience.

In response to the first radiator 110, such as the first radiator 110a being disposed opposite to the second side frame 212, the first radiator 110a may be located between the second radiator 120a and the first side frame 211. The second radiator 120a may be spaced apart from the first radiator 110a. The second wireless signal supported by the first radiator 110 may be, but is not limited to, the low frequency signal, the medium frequency signal, and the high frequency signal. For example, the first radiator 110 may support the transmission of signals in the B1 frequency band, the B3 frequency band, a B38 frequency band, or the B41 frequency band in the MIMO transmission mode of the DRX mode. For example, the first radiator 110 may support the transmission of signals in the N77 frequency band or the N78 frequency band in the PRX mode in the SA mode. For example, the first radiator 110 may support the transmission of signals in the N1 frequency band, the N3 frequency band, the N40 frequency band, or the N41 frequency band in the MIMO transmission mode of the DRX mode in the SA mode. For example, the first radiator 110 may support the transmission of signals in the N77 frequency band or the N78 frequency band in the PRX mode in the NSA mode. For example, the first radiator 110 may support the transmission of signals in the N1 frequency band, the N3 frequency band, the N40 frequency band, or the N41 frequency band in the DRX mode in the NSA mode. In response to the electronic device 10 including the plurality of first radiators 110, such as the first radiator 110a and the first radiator 110b, the two first radiators 110a and 110b may form the MIMO transmission system.

In response to the electronic device 10 or the antenna apparatus 100 supporting the 2G to 5G signals, the third radiator 150 may be used as a primary receiving antenna by default. In response to electronic device 10 being in a ENDC mode with dual connection between 4G and 5G signals, the third radiator 150 may be used as the primary receiving antenna for the 4G signals by default. In response to the electronic device 10 or the antenna apparatus 100 transmitting the N77 frequency band or the N78 frequency band, the first radiator 110 may be used as the primary receiving antenna by default, and the fifth radiator 170 may be used as the diversity receiving antenna by default. In response to the electronic device 10 or the antenna apparatus 100 being in a B20+N28 combination mode of the ENDC mode, the third radiator 150 may support the B20 frequency band by default, and the sixth radiator 180 may support the N28 frequency band by default.

The above description is only an exemplary explanation of the electronic device 10 in the embodiments of the present disclosure. For example, the electronic device 10 may further include more radiator structures, or the electronic device 10 may further include other imaging modules, sound electric conversion modules, etc. The embodiments of the present disclosure do not limit the specific structure of the electronic device 10.

In the antenna apparatus and electronic device of the present disclosure, the isolation degree between the second radiator in the operating state and the first radiator in the first state is greater than the isolation degree between the second radiator in the operating state and the first radiator in the second state. The control module controls the first radiator to be in the first state in response to the second radiator being in the operating state. In this case, the isolation degree between the first radiator and the second radiator is higher, the first radiator has less interference to the second radiator, and the radiation performance of the second radiator is better. Moreover, the antenna apparatus of the present disclosure may flexibly control the state of the first radiator based on the state of the second radiator, thereby reducing interference between two radiators and improving the radiation performance of the second radiator. The antenna apparatus reduces mutual interference between two radiators in a simpler and easier to operate way.

In the description of the present disclosure, the terms, such as “first” and “second”, are only configured to distinguish similar objects, and cannot be understood as indicating or implying relative importance or implying the number of indicated technical features.

The antenna apparatus and the electronic device provided in the embodiments of the present disclosure are described in detail, and specific examples are provided to describe and explain the principles and implementation modes of the present disclosure. The above explanation of the examples is only used to help understand the methods and core ideas of the present disclosure. Furthermore, according to the ideas of the present disclosure, those of ordinary skill in the art may change the specific implementation mode and the application scope. In summary, the contents of the present specification should not be understood as limiting the present disclosure.

What is claimed is:

1. An antenna apparatus, comprising:
a first radiator comprising a first state and a second state;
a second radiator configured to support transmission of a wireless signal in an operating state, wherein an isolation degree between the second radiator in the operating state and the first radiator in the first state is greater than an isolation degree between the second radiator in the operating state and the first radiator in the second state; and
a control module electrically connected to the first radiator and the second radiator, wherein the control module is configured to control the first radiator to be in the first state in response to the second radiator being in the operating state.

2. The antenna apparatus according to claim 1, further comprising:
a first chip electrically connected to the first radiator and the control module, wherein the first chip is configured to control the first radiator to be in the first state or the second state; and
wherein the control module is configured to control the first chip in response to the second radiator being in the operating state, so that the first radiator is in the first state.

3. The antenna apparatus according to claim 1, further comprising:
a second chip electrically connected to the second radiator and the control module, wherein the second chip is configured to control the second radiator to be in the operating state.

4. The antenna apparatus according to claim 1, wherein the second radiator is configured to support a wireless signal in a first frequency band in response to the second radiator being in the operating state;
the first radiator is configured to support a wireless signal in a second frequency band in response to the first radiator being in the first state, and support a wireless signal in a third frequency band in response to the first radiator being in the second state; and
a frequency difference between the second frequency band and the first frequency band is greater than a frequency difference between the third frequency band and the first frequency band.

5. The antenna apparatus according to claim 1, wherein the first radiator does not support the transmission of the wireless signal in response to the first radiator being operated in the first state.

6. The antenna apparatus according to claim 1, wherein the second radiator is configured to support transmission of a wireless fidelity signal in response to the second radiator being in the operating state; and/or
the first radiator is configured to support transmission of a cellular signal in response to the first radiator being in the second state.

7. An electronic device, comprising:
an antenna apparatus comprising:
a first radiator comprising a first state and a second state;
a second radiator configured to support transmission of a wireless signal in an operating state, wherein an isolation degree between the second radiator in the operating state and the first radiator in the first state is greater than an isolation degree between the second radiator in the operating state and the first radiator in the second state; and
a control module electrically connected to the first radiator and the second radiator, wherein the control module is configured to control the first radiator to be in the first state in response to the second radiator being in the operating state; and
a housing defining an accommodating space, wherein the first radiator is located in the accommodating space, and at least part of the second radiator is connected to the housing and located outside the accommodating space.

8. The electronic device according to claim 7, wherein the housing comprises a first side frame, a second side frame, and a third side frame sequentially connected; the first side frame and the third side frame are disposed opposite to each other, and a length of the first side frame and a length of the third side frame are less than a length of the second side frame; and
the second radiator is disposed opposite to the second side frame, and a ratio of a first distance between the second radiator and the first side frame to a second distance between the second radiator and the third side frame ranges from two-thirds to one and a half.

9. The electronic device according to claim 8, wherein the first radiator is disposed opposite to the second side frame, a first projection of the first radiator on the second side frame at least partially overlaps with a second projection of the second radiator on the second side frame, or the first projection is separated from the second projection.

10. The electronic device according to claim 7, wherein the electronic device comprises a plurality of first radiators and a plurality of second radiators; one of the plurality of first radiators and one of the plurality of second radiators form an antenna group, so that a plurality of antenna groups are formed;
and the control module is configured to control the first radiator of one of the plurality of the antenna groups to be in the first state in response to the second radiator of the same antenna group being in the operating state.

11. The electronic device according to claim 10, wherein the housing comprises a first side frame, a second side frame, a third side frame, and a fourth side frame sequentially connected; the first side frame and the third side frame are disposed opposite to each other, and the second side frame and the fourth side frame are disposed opposite to each other; and a length of the first side frame and a length of the third side frame are less than a length of the second side frame or a length of the fourth side frame; and
at least one of the plurality of antenna groups is disposed opposite to the second side frame, and at least another of the plurality of antenna groups is disposed opposite to the fourth side frame.

12. The electronic device according to claim 7, wherein the second radiator is a radiator with a flexible circuit board structure.

13. The electronic device according to claim 7, wherein the antenna apparatus further comprises:
a first chip electrically connected to the first radiator and the control module, wherein the first chip is configured to control the first radiator to be in the first state or the second state; and
wherein the control module is configured to control the first chip in response to the second radiator being in the operating state, so that the first radiator is in the first state.

14. The electronic device according to claim 7, wherein the antenna apparatus further comprises:
a second chip electrically connected to the second radiator and the control module, wherein the second chip is configured to control the second radiator to be in the operating state.

15. The electronic device according to claim 7, wherein the second radiator is configured to support a wireless signal in a first frequency band in response to the second radiator being in the operating state;
the first radiator is configured to support a wireless signal in a second frequency band in response to the first radiator being in the first state, and support a wireless signal in a third frequency band in response to the first radiator being in the second state; and
a frequency difference between the second frequency band and the first frequency band is greater than a frequency difference between the third frequency band and the first frequency band.

16. The electronic device according to claim 7, wherein the first radiator does not support the transmission of the wireless signal in response to the first radiator being operated in the first state.

17. The electronic device according to claim 7, wherein the second radiator is configured to support transmission of a wireless fidelity signal in response to the second radiator being in the operating state; and/or the first radiator is configured to support transmission of a cellular signal in response to the first radiator being in the second state.

18. The electronic device according to claim 7, wherein the housing comprises a middle frame and a rear housing, and the rear housing is connected to the middle frame to form the accommodating space.

19. The electronic device according to claim 18, further comprising:
a display screen, disposed on the middle frame and connected to the rear housing through the middle frame, so as to form a display surface;
a circuit board, disposed in the accommodating space; and
a battery, disposed in the accommodating space.

20. The electronic device according to claim 19, wherein the circuit board is integrated with one or more of a processor, a headphone interface, an acceleration sensor, a gyroscope, and a motor.
